(19) United States
(12) Patent Application Publication
(10) Pub. No.: US 2016/0352120 A1
(43) Pub. Date: Dec. 1, 2016

(54) ELECTRIC VEHICLE HIGH-VOLTAGE SYSTEM ALERT

(71) Applicant: Ford Global Technologies, LLC, Dearborn, MI (US)

(72) Inventors: Karin Lovett, Novi, MI (US); Cathleen Tistle, Manchester, MI (US); William David Treharne, Ypsilanti, MI (US)

(21) Appl. No.: 14/721,366

(22) Filed: May 26, 2015

(51) Int. Cl. H02J 7/00; B60L 11/18; F02N 11/08; B60W 20/00

(52) U.S. Cl. CPC H02J 7/0047; B60W 20/00; B60L 11/1811; H02J 7/0054; F02N 11/0807; B60W 2510/244; B60W 2710/06; Y10S 903/907

(57) ABSTRACT

A vehicle includes a traction battery, an auxiliary battery, a voltage converter selectively coupled with the traction battery and coupled with the auxiliary battery, an indicator, and a controller. The controller may be programmed to activate the indicator to indicate presence of a voltage on a high-voltage bus indicative of a current from the traction battery to the auxiliary battery during an ignition-off period in response to detecting an auxiliary voltage on a low-voltage bus less than a minimum voltage and a voltage on the high-voltage bus greater than a predetermined threshold.

### TECHNICAL FIELD

This application is generally related to charging an auxiliary battery from a traction battery in hybrid-electric and electric vehicles during ignition-off.

### BACKGROUND

Hybrid-electric and electric vehicles utilize a traction battery to provide power for propulsion and some accessory loads. Vehicles that utilize a high-voltage fraction battery may be referred to as electrified vehicles. These vehicles also include an auxiliary battery that outputs a lower voltage than the traction battery. The auxiliary battery provides power to various low voltage loads, electronics modules and may be used to start an engine. Also, the traction battery may supply power to electric machines for propulsion and may provide power to start the engine to provide propulsion. Electronic modules that receive power from the auxiliary battery typically require a certain voltage level to remain operable. If the auxiliary battery voltage falls below a certain voltage, operation of the electronic modules may not be guaranteed.

### SUMMARY

A vehicle includes a traction battery, an auxiliary battery, a voltage converter selectively coupled with the traction battery and coupled with the auxiliary battery, an indicator; and a controller. The controller is programmed to activate the indicator to indicate presence of a voltage on a high-voltage bus indicative of a current from a traction battery to an auxiliary battery during an ignition-off period in response to detecting an auxiliary voltage on a low-voltage bus less than a minimum voltage and a voltage on the high-voltage bus greater than a predetermined threshold.

A battery management system includes an indicator and at least one controller. The at least one controller is programmed to activate the indicator to indicate presence of a voltage on a high-voltage bus indicative of a current from a traction battery to an auxiliary battery during an ignition-off period in response to detecting an auxiliary voltage on a low-voltage bus less than a minimum voltage and a voltage on the high-voltage bus greater than a predetermined threshold

A method for generating a high-voltage indicator in a vehicle by a controller includes outputting a signal to activate the indicator in response to detecting a voltage on a high-voltage bus greater than a predetermined threshold indicative of a flow of electric charge from a traction battery to an auxiliary battery during an ignition-off period.

### BRIEF DESCRIPTION OF THE DRAWINGS

FIG. 1 is a diagram of a hybrid vehicle illustrating typical drivetrain and energy storage components.

FIG. 2 is a diagram of a control system for monitoring a high-voltage bus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

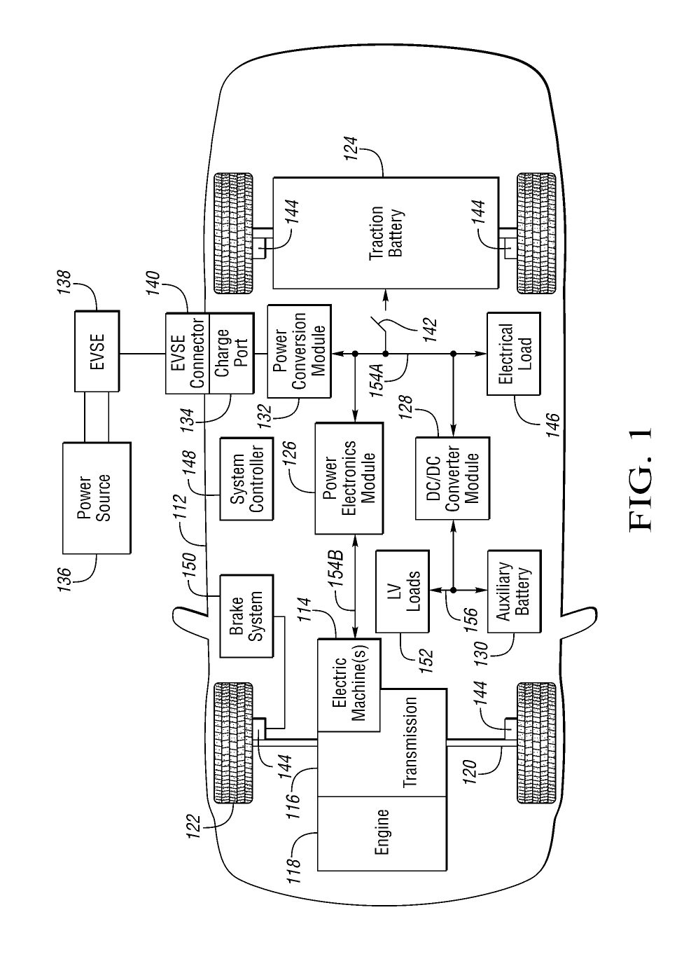

FIG. 1 depicts a typical plug-in hybrid-electric vehicle (PHEV). A PHEV 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and deceleration capability when the engine 118 is turned on or off. The electric machines 114 also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 stores energy that can be used by the electric machines 114. A vehicle battery pack 124 typically provides a high-voltage direct current (DC) output. One or more contactors 142 may isolate the traction battery 124 from a DC high-voltage bus 154A when opened and couple the traction battery 124 to the DC high-voltage bus 154A when closed. The traction battery 124 is electrically coupled to one or more power electronics modules 126 via the DC high-voltage bus 154A. The power electronics module 126 is also electrically coupled to the electric machines 114 and provides the ability to bi-directionally transfer energy between AC high-voltage bus 154B and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to an electric machine 114 and the engine 118 may not be present. The DC high-voltage bus 154A and the AC high-voltage bus 154B may be referred to individually or collectively as the high-voltage bus 154.

In addition to providing energy for propulsion, the traction battery 124 may provide energy for other vehicle electrical systems. A vehicle 112 may include a DC/DC converter module 128 that is electrically coupled to the high-voltage bus 154. The DC/DC converter module 128 may be electrically coupled to a low-voltage bus 156. The DC/DC converter module 128 may convert the high voltage DC output of the traction battery 124 to a low voltage DC supply that is compatible with low-voltage vehicle loads 152. The low-voltage bus 156 may be electrically coupled to an auxiliary battery 130 (e.g., 12V battery). The low-voltage systems 152 may be electrically coupled to the low-voltage bus 156. The low-voltage system 152 may include various controllers within the vehicle 112. If the voltage of the auxiliary battery 130 falls below a minimum threshold voltage, the low-voltage systems 152 may not be able to power up and operate. The result of the low-voltage systems 152 being inoperative may be a loss of ability to start the vehicle. For example, if a controller that manages the traction battery 124 cannot be powered up, the contactors 142 may remain open.

The vehicle 112 may be an electric vehicle or a plug-in hybrid vehicle in which the traction battery 124 may be recharged by an external power source 136. The external power source 136 may be a connection to an electrical outlet. The external power source 136 may be electrically coupled to a charger or electric vehicle supply equipment (EVSE) 138. The external power source 136 may be an electrical power distribution network or grid as provided by an electric utility company. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

One or more wheel brakes 144 may be provided for decelerating the vehicle 112 and preventing motion of the vehicle 112. The wheel brakes 144 may be hydraulically actuated, electrically actuated, or some combination thereof. The wheel brakes 144 may be a part of a brake system 150. The brake system 150 may include other components to operate the wheel brakes 144. For simplicity, the figure depicts a single connection between the brake system 150 and one of the wheel brakes 144. A connection between the brake system 150 and the other wheel brakes 144 is implied. The brake system 150 may include a controller to monitor and coordinate the brake system 150. The brake system 150 may monitor the brake components and control the wheel brakes 144 for vehicle deceleration. The brake system 150 may respond to driver commands via a brake pedal and may also operate autonomously to implement features such as stability control. The controller of the brake system 150 may implement a method of applying a requested brake force when requested by another controller or sub-function.

One or more high-voltage electrical loads 146 may be coupled to the high-voltage bus 154. The high-voltage electrical loads 146 may have an associated controller that operates and controls the high-voltage electrical loads 146 when appropriate. The high-voltage loads 146 may include compressors and electric heaters.

The various components discussed may have one or more associated controllers to control and monitor the operation of the components. The controllers may communicate via a serial bus (e.g., Controller Area Network (CAN)) or via discrete conductors. In addition, a system controller 148 may be present to coordinate the operation of the various components.

During an ignition-off condition, the contactors 142 may be in an open state so that the traction battery 124 does not provide power to the high-voltage bus 154. During the ignition-off condition, the traction battery 124 may be decoupled from the auxiliary battery 130. During the ignition-off condition, selected electronic modules (e.g., low-voltage loads 152) may be active. For example, a theft-deterrent system and a remote keyless entry system may continue to be active. The active systems may draw current from the auxiliary battery 130. In some configurations, low-voltage loads 152, such as lamps, may be accidently left in an active condition and draw current from the auxiliary battery 130, which may increase a rate of discharge of the auxiliary battery 130. During the ignition-off condition, the low-voltage loads 152 may be configured to minimize current draw.

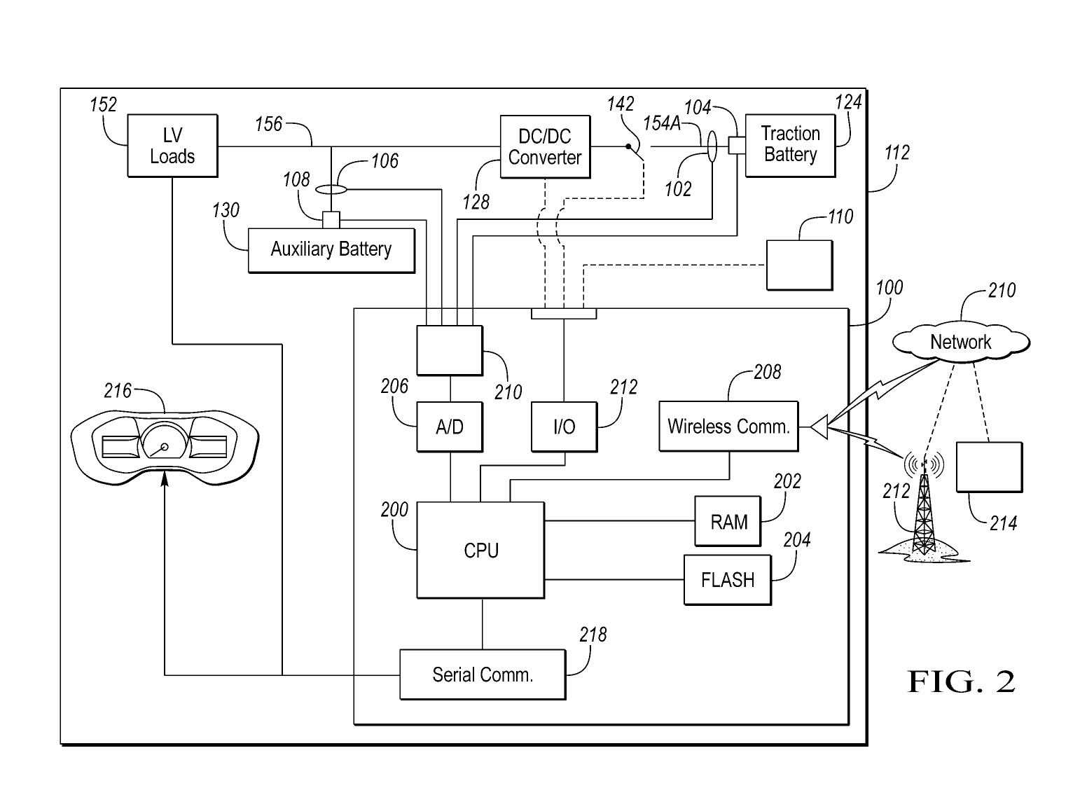

FIG. 2 depicts one possible diagram of a controller 100 that interfaces with the auxiliary battery 130 and the traction battery 124 to implement a battery management system. The controller 100, although represented as a single controller, may be implemented as one or more controllers. The controller 100 may monitor operating conditions of the traction battery 124 and the auxiliary battery 130. A traction battery current sensor 102 may be coupled to the traction battery 124 to sense a current that flows through the fraction battery 124. A traction battery voltage sensor 104 maybe coupled to the traction battery 124 to sense a voltage across terminals of the traction battery 124. The traction battery voltage sensor 104 may output a signal indicative of the voltage across the terminals of the traction battery 124. The traction battery current sensor 102 may output a signal of a magnitude and direction of current flowing through the traction battery 124.

An auxiliary battery current sensor 106 may be coupled to the auxiliary battery 130 to sense a current that flows through the auxiliary battery 130. An auxiliary battery voltage sensor 108 may be coupled to the auxiliary battery 130 to sense a voltage across terminals of the auxiliary battery 130. The auxiliary battery voltage sensor 108 may output a signal indicative of the voltage across the terminals of the auxiliary battery 130. The auxiliary battery current sensor 106 may output a signal of a magnitude and direction of current flowing through the auxiliary battery 130.

The outputs of traction battery current sensor 102 and the traction battery voltage sensor 104 may be input to the controller 100. The outputs of the auxiliary battery current sensor 106 and the auxiliary battery voltage sensor 108 may be input to the controller 100. The controller 100 may include interface circuitry 210 to filter and scale the current sensor signals and the voltage sensor signals.

The controller 100 may be configured to compute a state of charge of the traction battery 124 based on the signals from the traction battery current sensor 102 and the traction battery voltage sensor 104. Various techniques may be utilized to compute the state of charge. For example, an ampere-hour integration may be implemented in which the current through the traction battery 124 is integrated over time. The state of charge may also be estimated based on the output of the traction battery voltage sensor 104. The specific technique utilized may depend upon the chemical composition and characteristics of the particular battery. Similarly, the controller 100 may compute a state of charge of the auxiliary battery 130 based on the signals from the auxiliary battery current sensor 106 and the auxiliary battery voltage sensor 108. In some configurations, the state of charge of the auxiliary battery 130 may be estimated from the output of the auxiliary battery voltage sensor 108.

A state of charge operating range may be defined for the auxiliary battery 130 and the traction battery 124. The operating ranges may define an upper and lower limit at which the state of charge may be bounded for each battery 124, 130. During vehicle operation, the controller 100 may be configured to maintain the state of charge of the batteries 124, 130 within the associated operating range. During the ignition-off condition, the state of charge of the auxiliary battery 130 may decrease due to low-voltage loads 152 that operate during the ignition-off condition as well as any parasitic loads that may be present in the low-voltage loads 152. However, the state of charge of the traction battery 124 may decrease at a much slower rate as the traction battery 124 may be disconnected from high-voltage electrical loads 146 by an open switch 142. Although the switch 142 is open, the traction battery 124 has some losses that may include internal battery monitoring circuitry and internal traction battery chemical reactions. In addition, if the contactors 142 are closed, the DC/DC Converter Module 128 may be activated and draw power from the traction battery 124 to supply the low-voltage bus 156. The supplying of energy such as flowing an electric charge or current from the traction battery 124 to the auxiliary battery 130 while the vehicle is in a key-off state may reduce instances in which the vehicle becomes inoperative due to a lack of charge on the auxiliary battery 130. The high-voltage bus 154 must be energized and the DC/DC converter must change the voltage level of the traction battery 124 to the voltage of the auxiliary battery 130 in order to flow an electric charge between the batteries 124, 130. Typically when the vehicle is in an operational state, there may be a presence of a high-voltage, for example a voltage greater than 100 volts, on the high-voltage bus 154. The vehicle in the operational state may be determined by both visual and audible indications including sounds and vibrations associated with an operation of an engine, illuminations of an interior instrument cluster 216, and operation of an infotainment system. However, when the vehicle is in a key-off state, the instrument cluster and infotainment system are typically off even when the traction battery 124 is flowing an electric charge to the auxiliary battery 130. Here, an indicator such as an infotainment system, a light emitting device (such as a lamp or light emitting diode) or an instrument cluster 216 may be operated or illuminated in response to a presence of a high-voltage on a high-voltage bus 154.

As the state of charge of the auxiliary battery 130 decreases, the voltage of the auxiliary battery 130 may decrease. An auxiliary battery low-voltage limit may be defined. The auxiliary battery low-voltage limit may be configured to be a voltage level at which the auxiliary battery 130 should be charged to ensure that sufficient energy is stored in the auxiliary battery 130 to support the low-voltage loads 152 during ignition-off conditions for a predetermined period of time. Additionally, an auxiliary battery minimum voltage limit may be defined as that voltage level below which the low-voltage loads 152 may not be able to operate. The auxiliary battery voltage limits may also be defined as auxiliary battery state of charge limits. Similarly, traction battery low-voltage limits or state of charge limits may be defined.

In an electrified vehicle, stored energy from the traction battery 124 may be used to charge the auxiliary battery 130. During vehicle operation (e.g., an ignition-on condition) energy from the traction battery 124 and the electric machines 114 may be used to provide power to the auxiliary battery 130 and low-voltage loads 152 via the DC/DC converter module 128. However, in an ignition-off condition, the contactors 142 may be opened so that the traction battery 124 is isolated from the DC/DC converter module 128. In this situation, no energy is transferred from the traction battery 124 to the auxiliary battery 130 as the batteries are decoupled. Some electrified vehicles include a high-voltage interlock mechanism coupled with the voltage converter 128, traction battery 124 and the controller 100. The high voltage interlock mechanism includes a safety circuit designed to prevent energizing high-voltage power supplies such as batteries until all access points and connections are closed, and to immediately de-energize such power supplies if any access point or connection is opened. An electrified vehicle with a high-voltage interlock mechanism requires the mechanism to be activated before a high voltage can be applied to the high-voltage bus 154. However, a deactivated high-voltage interlock mechanism does not necessarily ensure full discharge of stored energy within components located on the high-voltage bus 154 and therefore may still have a presence of a high voltage on the high-voltage bus 154.

The controller 100 may be configured to monitor the status of the auxiliary battery 130 and request an energy transfer from the traction battery 124 to charge the auxiliary battery 130 under various conditions. In some configurations, the controller 100 may compare the voltage of the auxiliary battery 130 to the auxiliary battery low-voltage limit. In response to the auxiliary battery voltage being less than the auxiliary battery low-voltage limit, the controller 100 may request the energy transfer from the traction battery 124. In some configurations, the controller 100 may compare the auxiliary battery state of charge to an auxiliary battery low state of charge limit. In response to the auxiliary battery state of charge being less than the auxiliary battery low state of charge limit, the controller 100 may request the energy transfer from the traction battery 124. The controller 100 may monitor the status during ignition-off conditions. To reduce power consumption by the controller 100 during ignition-off conditions, the controller 100 may be configured to periodically wake up to check the status of the auxiliary battery 130. The periodic wake up may be based on a fixed interval timer or may be based on reception of a signal from a nomadic device 214 in communication with the controller 100.

Conditions in which a transfer of energy from the traction battery 124 to the auxiliary battery 130 is inhibited may include the traction battery voltage being less than a predetermined voltage. The conditions may also include the traction battery state of charge being less than a predetermined state of charge. The predetermined voltage and predetermined state of charge may be a level at which the traction battery 124 is not operated due to performance or battery life considerations. Other conditions may include diagnostic conditions that inhibit operation of the traction battery 124. In some configurations, diagnostic conditions pertaining to the DC/DC converter module 128 may inhibit the transfer of energy. The low-voltage alert may be conditioned upon the inability to transfer energy from the traction battery 124. In the event that the traction battery voltage is below a predetermined high-voltage battery threshold and the auxiliary battery voltage is less than an auxiliary-battery threshold and there is fuel in a fuel tank of the vehicle, the controller 100 may output a signal to start the engine to charge the traction battery 124 and the auxiliary battery 130.

In response to a request for the energy transfer from the traction battery 124 during an ignition-off, the contactors 142 may be closed to couple the traction battery 124 to the DC/DC converter 128 and ultimately the auxiliary battery 130. Upon the presence of high voltage on the high-voltage bus 154, the high-voltage indicator will be activated. In some configurations, closing the contactors 142 may activate operation of the DC/DC converter 128. In some configurations, the controller 100 may manage and control operation of the DC/DC converter 128 after the contactors 142 are closed via one or more control signals. This request may occur when the vehicle is in a key-off or ignition-off state.

The controller 100 may include a processor 200 that controls at least some portion of the operation of the controller 100. The processor 200 allows onboard processing of commands and routines. The processor 200 may be coupled to non-persistent storage 202 and persistent storage 204. In this illustrative configuration, the non-persistent storage 202 is random access memory (RAM) and the persistent storage 204 is flash memory. In general, persistent (non-transitory) storage 204 can include all forms of storage that maintain data when a computer or other device is powered down.

The processor 200 may be coupled to an Analog-to-Digital converter 206 that is configured to convert analog signals to digital form. For example, the outputs from the interface circuitry 210 for the current and voltage sensor signals may be coupled to the A/D converter 206 for input to the processor 200.

The vehicle 112 may include an indicator 110 (e.g., a lamp being a device that emits light including an incandescent bulb, a vacuum florescence display (VFD), a light emitting diode (LED) or a portion of a display screen) that is configured to indicate a presence of a high voltage on the high voltage bus 154. The indicator 110 may be within the vehicle 112 such as on the vehicle dashboard such that when illuminated, the light waves from the light emitting device are visible to both the interior and exterior of the vehicle 112. When the operator is not in the vicinity of the vehicle 112, a different means of providing the indicator may be desired. The controller 100 may be programmed to output the high-voltage indicator in response to the presence of a high voltage on the high-voltage bus 154 during the transfer of energy from the traction battery 124 to the auxiliary battery 130 during the ignition-off period.

Along with the indicator 110, an infotainment system, an engine, or an instrument cluster 216 may be used to indicate the presence of a high voltage on the high-voltage bus 154 by sending signals on a serial communications bus coupled to the serial communication module 218. The infotainment system may activate a chime or speaker to output sound waves as an indicator of a presence of a high voltage on the high-voltage bus 154. The instrument cluster 216 may illuminate or power-on as an indicator of a presence of a high voltage on the high-voltage bus 154. The illumination of the instrument cluster 216 may include illuminating an indicator such as an incandescent bulb, a vacuum florescence display (VFD), a light emitting diode (LED) or a portion of a display screen. The engine 118 may operate to generate vibrations and sounds associated with the operation of the engine as an indicator of a presence of a high voltage on the high-voltage bus 154.

The controller 100 may include a wireless communications module 208 to communicate with nomadic devices 214 (e.g., smart phone, smart watch, electronic tablet, computer) remote from the vehicle 112. The wireless communications module 208 may include an onboard modem having an antenna to communicate with off-board devices 214. The wireless communications module 208 may be a cellular communications device to enable communications via a cellular data network 212. The wireless communications module 208 may be a wireless local area network (LAN) device compatible with the IEEE 802.11 family of standards (i.e., WiFi) or a WiMax network. The wireless communications module 208 may include a vehicle based wireless router to allow connection to remote networks 210 in range of a local router. The wireless communications module 208 may be configured to establish communication with a nomadic device 214 (e.g., phone, tablet, computer). The nomadic device 214 may be connected to an external network 210. The controller 100 may be programmed to implement an appropriate communications protocol in hardware and software that is compatible with a selected mode of wireless communication. Although depicted as part of the controller 100, the wireless communications module 208 may be part of a different controller within the vehicle 112 and the controller 100 may interface with the difference controller via the serial communications bus.

The high-voltage indicator may be communicated via the wireless communications module 208 to the nomadic device 214. The nomadic device 214 may include a processor and associated volatile and non-volatile memory that is configured to store and execute programs or applications. For example, the nomadic device 214 may execute an application such as MyFord Mobile that is configured to transfer vehicle related status and commands between the nomadic device 214 and the vehicle 112. In some configurations, the nomadic device 214 may include a web browser application. Communication with the vehicle 112 may be established via a web-based interface. The nomadic device 214 may receive a communication that includes the high-voltage indicator. The nomadic device 214 may display the high-voltage indicator to the operator on a display screen associated with the nomadic device 214. Upon receiving the high-voltage indicator, the operator may decide upon a course of action.

The nomadic device 214 may include various ways of indicating the high-voltage indicator. The application may run as a background task and periodically monitor for a received message. When a message is received that includes the high-voltage indicator, a notification may be generated. The notification may interrupt a currently running application. Further, if the nomadic device 214 is in a sleep state, the application may wake up the nomadic device 214 to indicate the high-voltage indicator. The application may indicate the high-voltage indicator with a visual indication (e.g., illumination of a light emitting device, blinking of the light emitting device, illumination of the instrument cluster 216, powering on the instrument cluster 216, displaying an on-screen message, or flashing a light), an audible indication (e.g., sound through a speaker or chime), and/or a tactile indication (e.g., vibration of the nomadic device 214).

In response to the high-voltage indicator, the operator may visit the vehicle 112 and start the engine 118 for a period of time to allow the traction battery 124 and auxiliary battery 130 to recharge. The battery management system may be configured to ensure that the low-voltage alert is issued when there is sufficient energy remaining in the traction battery 124 and the auxiliary battery 130 to start the vehicle 112. The state of charge of the traction battery 124 may be such that an amount of energy is stored in the traction battery 124 that is sufficient to start the engine 118. The voltage and state of charge of the auxiliary battery 130 may be such that an amount of energy stored in the auxiliary battery 130 is sufficient to supply an ignition-off load for a predetermined time.

In some configurations, the application executed by the nomadic device 214 may provide an option for the operator to start the engine 118 remotely. In response to receiving the high-voltage indicator, the operator may command an ignition-on via the application executed by the nomadic device 214. The controller 100 may be configured to receive the ignition-on command and issue instructions within the vehicle 112 to start the engine 118. The controller 100 may command operation of the power electronics module 126 and electric machines 114 to generate electricity. The controller 100 may maintain the engine 118 in a running condition until the traction battery 124 has achieved a predetermined state of charge and/or voltage and the auxiliary battery 130 has achieved a predetermined state of charge and/or voltage. Or the controller 100 may maintain the engine 118 in a running condition for a predetermined time such as 15 minutes. When the batteries 124, 130 are sufficiently charged, the controller 100 may issue instructions to stop the engine 118 and return to the ignition-off condition. Additional conditions may be implemented to enable starting the engine 118. For example, the controller 100 may determine that the vehicle 112 is in a ventilated area and that sufficient fuel is available before starting the engine 118.

In some configurations, the controller 100 may be configured to automatically start the engine in response to the high-voltage indicator. This option may be configurable by the operator. The high-voltage indicator may still be output along with an engine status indication. In an electric-vehicle configuration, the operator may be able to remotely command a presence of a high voltage on the high-voltage bus 154, the high-voltage indicator, and charging of the vehicle 112 provided that the charger 138 is connected to the vehicle 112 and operational. In other electric-vehicle configurations, a presence of a high voltage on the high-voltage bus 154, the high-voltage indicator, and charging of the traction battery 124 may occur automatically when the charger 138 is connected and operational.

The low-voltage alert strategy may be applicable to any vehicle that includes a traction battery 124 and an auxiliary battery 130. For example, electric vehicles may include the auxiliary battery 130 to retain compatibility with low-voltage components. The electric vehicle or plug-in hybrid-electric vehicle may be placed on a charger 138 during periods of non-use. The low-voltage strategy is still applicable as there may be situations in which the charger 138 and/or the external power source 136 are non-functional. The low-voltage alert serves to remind the operator to plug in the charge connector 140 or otherwise confirm operation of the charging equipment 138. In the event that the charger 138 is connected and operational, the low-voltage alert may not be issued as the auxiliary battery 130 may be charged to a level above the warning threshold.

The low-voltage alert may be removed when the auxiliary battery 130 has been recharged above a predetermined voltage level or predetermined state of charge level. The level may be greater than the voltage or state of charge threshold below which the low-voltage alert is generated. The low-voltage alert may be removed when conditions that inhibit the transfer of energy from the traction battery 124 are no longer present.

The functions described may be implemented in a single controller 100 or the functions may be implemented in multiple controllers. In a system having multiple controllers, data may be communicated between controllers via the serial communications bus. Components shown and described may be coupled to one or more of the multiple controllers.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a fraction battery;
a voltage converter selectively coupled with the traction battery;
an auxiliary battery coupled with the voltage converter;
an indicator; and
a controller programmed to, in response to selectively coupling the traction battery to the voltage converter via a high-voltage bus to provide current from the traction battery to the auxiliary battery during an ignition-off period, activate the indicator to indicate a presence of a voltage on the high-voltage bus.

2. The vehicle of claim 1, wherein the indicator is a light emitting device mounted on a dashboard of the vehicle and wherein activating the indicator includes causing the light emitting device to blink such that light waves propagate to an interior of the vehicle and to an exterior of the vehicle.

3. The vehicle of claim 1 further including an instrument cluster, including a cluster face, coupled to the controller, wherein the indicator is a light emitting device on the cluster face of the instrument cluster and activating the indicator is illuminating the light emitting device.

4. The vehicle of claim 1, wherein the indicator is a chime and activating the indicator causes sound waves to emit from the chime.

5. The vehicle of claim 1, further comprising a high-voltage interlock mechanism coupled with the voltage converter, traction battery and the controller, and configured to selectively couple the traction battery to the voltage converter in response to activation of the high-voltage interlock mechanism.

6. The vehicle of claim 1 further comprising a wireless communications module coupled to the controller, and wherein activating the indicator includes outputting an alert via the wireless communications module to a device remote from the vehicle.

7. The vehicle of claim 6 further comprising an engine and an electric machine mechanically coupled to the engine and electrically coupled to the traction battery, and wherein the controller is further programmed to receive an ignition-on request from the device via the wireless communications module, and in response to the ignition-on request, start the engine and operate the electric machine to generate electricity to recharge the traction battery and the auxiliary battery.

8. The vehicle of claim 1 further comprising an engine and an electric machine mechanically coupled to the engine and electrically coupled to the traction battery, and wherein the controller is further programmed to, in response to activation of the indicator and a state of charge of the traction battery being less than a predetermined threshold, output an engine-start signal and operate the electric machine to generate electricity to recharge the traction battery and the auxiliary battery.

9. A battery management system comprising:
an indicator; and
at least one controller programmed to, in response to detecting an auxiliary voltage on a low-voltage bus less than a minimum voltage and a voltage on a high-voltage bus greater than a predetermined threshold indicative of a current from a traction battery to an auxiliary battery during an ignition-off period, activate the indicator to indicate presence of the voltage on the high-voltage bus.

10. The battery management system of claim 9 further including an instrument cluster having a cluster face and coupled to the controller, wherein the indicator is a light emitting device on the cluster face and wherein activating the indicator includes illuminating the light emitting device.

11. The battery management system of claim 9 further including a wireless communications module coupled to the at least one controller, wherein the at least one controller is further programmed to transmit the indicator via the wireless communications module to a remote device in response to detecting a voltage on the high-voltage bus.

12. The battery management system of claim 11, wherein the at least one controller is further programmed to receive an ignition-on request from the remote device via the wireless communications module, and in response to the ignition-on request, output an engine-start signal and command an electric machine to generate electricity to recharge the traction battery and the auxiliary battery.

13. The battery management system of claim 9, wherein the at least one controller is further programmed to, in response to the indicator and a state of charge of the traction battery being less than a predetermined threshold, output an engine-start signal and operate an electric machine to generate electricity to recharge the traction battery and the auxiliary battery.

14. A method for generating a high-voltage indicator in a vehicle, the method comprising:
outputting, by a controller, a signal to activate an indicator, in response to detecting a voltage on a high-voltage bus greater than a predetermined threshold indicative of a flow of electric charge from a traction battery to an auxiliary battery during an ignition-off period.

15. The method of claim 14 further comprising, in response to the outputting, starting an engine of the vehicle and operating an electric machine coupled to the engine to recharge the traction battery and the auxiliary battery.

16. The method of claim 14, further comprising, in response to the outputting, illuminating by a light emitting device mounted on a dashboard of the vehicle an interior of the vehicle and an exterior of the vehicle.

17. The method of claim 14 further comprising, in response to the outputting, illuminating a lamp on a cluster face of an instrument cluster.

18. The method of claim 14, further comprising, in response to the outputting, emitting sound waves from a chime.

19. The method of claim 14 further comprising transmitting, by the controller, the signal to a device remote from the vehicle.

20. The method of claim 19 further comprising
receiving an ignition-on request from the device; and
outputting, by the controller, an engine-start signal.
